(19) United States
(12) Patent Application Publication
(10) Pub. No.: US 2025/0199944 A1
(43) Pub. Date: Jun. 19, 2025

(54) SOFTWARE TESTING SERVICE WITH AUTOMATED FAILURE REPRODUCTION AND ROOT CAUSE ANALYSIS

(71) Applicant: Amazon Technologies, Inc., Seattle, WA (US)

(72) Inventors: Francesco Piai, Madrid (ES); Patrick Bartsch, Wolfsburg (DE)

(73) Assignee: Amazon Technologies, Inc., Seattle, WA (US)

(21) Appl. No.: 18/542,461

(22) Filed: Dec. 15, 2023

(51) Int. Cl. G06F 11/36

(52) U.S. Cl. CPC G06F 11/3688; G06F 11/3692

(57) ABSTRACT

A cloud-based software testing service orchestrates the testing of pieces of software, such as software to be deployed to a vehicle. Also, the cloud-based software testing service, in response to detecting a failure, automatically instantiates multiple virtual machines configured to emulate a testing environment for testing one or more of the pieces of software, with which the detected failure is associated. These virtual machines allow for rapid execution of multiple instances of re-testing to be performed to determine a reproducibility measure for the failure. Based on the reproducibility measure, additional re-testing may be performed. Expanded testing logs generated during the re-testing are provided to a trained machine learning model that automatically determines, for reproducible failures, a root cause of the failure.

### BACKGROUND

Software to be deployed to vehicles often requires significant testing, such as certification testing to ensure the software operates as expected when the vehicle in on the road. Also, vehicles often include electronic control units and/or software provided by multiple vendors. Thus, not only are software module tests performed to test each piece of software, software integration tests are performed to test how different pieces of software interact with one another and with hardware included in a vehicle.

Typically, when a piece of software fails during such testing, an engineer or other member of a design team troubleshoots the failure to determine a root cause of the failure. For example, the engineer may use debugging software to analyze the failure. However, this may be a time consuming and manual process. Also, some failures may be intermittent, such that the engineer is unable to reproduce the failure, and therefore unable to correct a cause of the failure.

### BRIEF DESCRIPTION OF THE DRAWINGS

FIG. 1 illustrates a cloud-based service provider network that includes a software testing service configured to detect a failure occurring during a test run, automatically instantiate multiple computing instance to repeat a test of the test run in which the failure occurred, determine a reproducibility measure of the failure, and automatically determine a root cause for the failure using a machine learning (ML) model, according to some embodiments.

FIG. 2 illustrates a logical diagram of actions performed by a test failure handling module of a software testing service in response to a failure occurring during a test of a test run being executed by the software testing service, according to some embodiments.

FIG. 3 illustrates interactions between components of the test failure handling module in response to different fest failures having different reproducibility measures, according to some embodiments.

FIG. 4 illustrates an example failure reproduction plan to be executed by a retest execution orchestration module of the test failure handling module, according to some embodiments.

FIG. 5 illustrates another example failure reproduction plan, for example that may be used to determine a reproducibility measure for failures that are less reproducible than failures for which the failure reproduction plan shown in FIG. 4 is used, according to some embodiments.

FIG. 6 illustrates an additional example failure reproduction plan, wherein compute instance type and/or compute instance environment are varied to better reproduce the failure, according to some embodiments.

FIG. 7 illustrates yet another example failure reproduction plan, wherein runtime context is expanded by performing a threshold number of prior tests (that passed) prior to repeating the test that failed, according to some embodiments.

FIG. 8 illustrates logging performed during a test of a test run (for example under normal testing conditions prior to detecting a failure), according to some embodiments.

FIG. 9 illustrates logging performed during a re-test of a rest run (for which a failure has been detected), wherein expanded logging is performed, according to some embodiments.

FIG. 10 illustrates a process for training and using a machine learning model to determine root causes of failures based on expanded logs generated during re-testing, according to some embodiments.

FIG. 11 illustrates a process for training and using a machine learning model to generate expanded logging plans, wherein expanded logging is strategically deployed to software tasks that are predicted to be associated with a failure that is trying to be reproduced, according to some embodiments.

FIG. 12 is a flowchart illustrating a process of determining a root cause for a failure occurring during a given test of a test run, wherein automatic instantiation of computing instances is used to reproduce the failure and a machine learning model is used to analyze re-test logs to determine a root cause of the failure, according to some embodiments.

FIG. 13 illustrates a block diagram illustrating an example computer system that implements some or all of the techniques described herein, according to some embodiments.

While embodiments are described herein by way of example for several embodiments and illustrative drawings, those skilled in the art will recognize that embodiments are not limited to the embodiments or drawings described. It should be understood that the drawings and detailed description thereto are not intended to limit embodiments to the particular form disclosed, but on the contrary, the intention is to cover all modifications, equivalents and alternatives falling within the spirit and scope as defined by the appended claims. The headings used herein are for organizational purposes only and are not meant to be used to limit the scope of the description or the claims. As used throughout this application, the word “may” is used in a permissive sense (e.g., meaning having the potential to), rather than the mandatory sense (e.g., meaning must). Similarly, the words “include,” “including,” and “includes” mean including, but not limited to.

### DETAILED DESCRIPTION OF EMBODIMENTS

The systems and methods described herein include techniques for implementing a cloud-based vehicle software testing service (or testing service for other types of software). In some embodiments, a software testing service is included in a service provider network that also includes other services, such as a computing service configured to provide compute instances for executing computing jobs, such as software testing, as well as a storage service for storing test results, test plans, logs, etc. In some embodiments, the computing instances offered by the computing service may emulate hardware and environmental conditions likely to be experienced when the software being tested is deployed. For example, the computing service may include computing resources configured to emulate various electronic control unit (ECU) configurations used in vehicles. Also, the computing service may emulate environmental conditions experienced by computing devices included in vehicles, such as hot and cold temperatures, etc.

In some embodiments, a software testing service may orchestrate testing of software in real-world vehicles or using computing instances that emulate vehicle conditions. The software testing may include performing one or more test runs, each test run comprising multiple tests that are to be performed using the software being tested. For example, if the software being tested is an infotainment feature, a test run may include testing the infotainment software feature in combination with various other infotainment applications, as well as in various conditions (e.g., with other vehicle systems on, other vehicle systems off, in various locations in a sequence of commands for vehicle systems to perform various operations, in a hot vehicle, in a cold vehicle, etc.). The purpose of the testing is to verify that the software will function as intended when deployed in the real-world, as well as interact with other software models as intended, when deployed in the real-world. In some embodiments, the software testing may be required for certification of the software. For example, vehicle software is often required to be certified before being deployed into a vehicle. In some embodiments, the certification, for which testing is performed, may be automotive safety integrity level (ASIL) certification.

In response to a failure occurring during a given test of a test run, the software testing service automatically instantiates multiple computing instances of the computing service of the service provider network in order to reproduce the failure. For example, if the testing is being performed using a real-world vehicle, compute instances in the cloud may nevertheless be used to emulate the vehicle test and reproduce the failure. Also, if the testing is initially being performed in the cloud using an emulated computing environment for a vehicle, the re-testing may also be performed in the cloud using automatically instantiated computing instances. Automatically instantiating computing instances in the cloud to determine a reproducibility of the failure allows for parallelization and a much faster determination of a reproducibility measure than if the failure was attempted to be recreated by repeating the given test or the test run on a vehicle or using a single emulated computing environment for a vehicle.

In some embodiments, various actions may be taken by the testing service based on a determined reproducibility measure. For example, if the failure is easily reproducible, such that the reproducibility measure satisfies a first threshold, re-testing may be performed using expanded logging. If the failure cannot be reproduced, such that the reproducibility measure is below a second threshold, an error message or other message may be provided indicating that the failure cannot be reproduced and therefore a root cause cannot be determined. In other situations, the reproducibility measure may satisfy a third threshold, in which case expanded reproduction plans may be deployed to better determine conditions that cause the failure to be reproduced. For example, more runs of the given test associated with the failure may be executed using the same or more computing instances to better determine the conditions that cause reproduction of the failure. Also, different computing instance types and/or environmental conditions may be used in subsequent runs of the given test to better determine conditions that cause the failure to be reproduced.

In response to the failure being successfully reproduced, the software testing service may proceed to re-test the software for a given test or set of tests of a test run with expanded logging enabled. In some embodiments, a trained machine learning model may be used to determine which tasks expanded logging is to be implemented for. For example, implementing expanded logging on all tasks may alter computing conditions, such as processor load and/or memory usage. Thus, strategically implementing expanded logging for some, but not all tasks, may improve re-test execution.

Logs generated during the re-testing and/or other logs from the initial testing may be provided to a second trained machine learning model. The second trained machine learning model may have been trained to identify root causes of failures based on execution logs, such as the initial and expanded logs. In some embodiments, annotated training data comprising manually determined root causes and associated logs may be used to train the second machine learning model. In some embodiments, similar training data may also be used to train the first machine learning model. For example, the first machine learning model may determine relationships between tasks and root causes, in order to determine which tasks expanded logging should be enabled for.

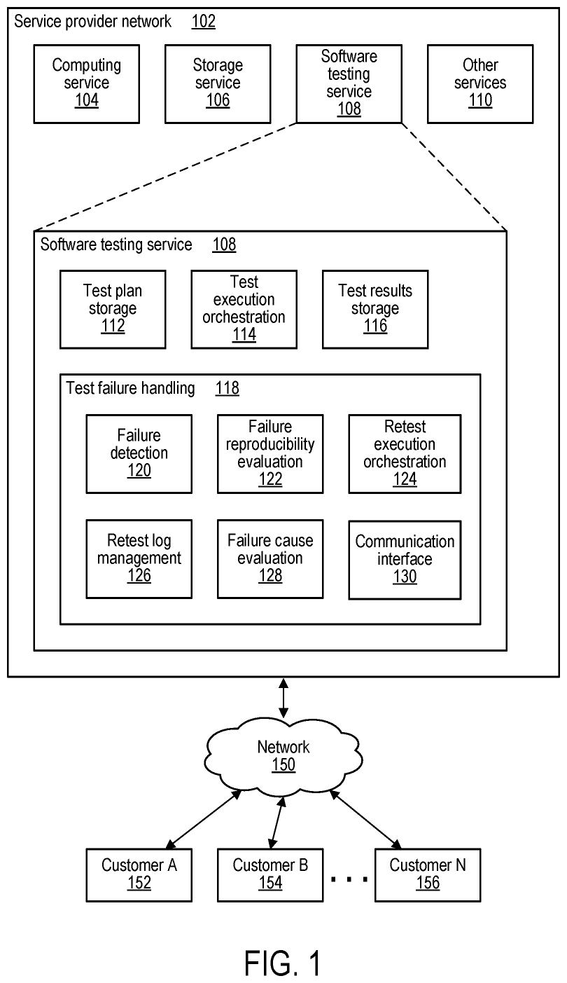

FIG. 1 illustrates a cloud-based service provider network that includes a software testing service configured to detect a failure occurring during a test run, automatically instantiate multiple computing instance to repeat a test of the test run in which the failure occurred, determine a reproducibility measure of the failure, and automatically determine a root cause for the failure using a machine learning (ML) model, according to some embodiments.

In some embodiments, a software testing service, such as software testing service 108, may be implemented in a cloud-environment, such as in service provider network 102. In some embodiments, service provider network 102 may include other services, such as computing service 104, storage service 106, and other services 110.

In some embodiments, a service provider network 102 may be a cloud provider network. A cloud provider network, such as service provider network 102, may provide access to computing resources via a defined set of regions, availability zones, and/or other defined physical locations where a cloud provider network includes data centers in one or more regions. In many cases, each region represents a geographic area (e.g., a U.S. East region, a U.S. West region, an Asia Pacific region, and the like) that is physically separate from other regions, where each region can include two or more availability zones connected to one another via a private high-speed network, e.g., a fiber communication connection. In some embodiments service provider network 102 may include multiple physical or infrastructure availability zones, where a physical or infrastructure availability zone (also known as an availability domain, or simply a “zone”) refers to an isolated failure domain including one or more data center facilities with separate power, separate networking, and separate cooling from those in another availability zone. Preferably, physical availability zones within a region are positioned far enough away from one other that the same natural disaster should not take more than one availability zone offline at the same time, but close enough together to meet a latency requirement for intra-region communications.

Furthermore, regions of a cloud provider network, such as service provider network 102, may be connected to a global “backbone” network which includes private networking infrastructure (e.g., fiber connections controlled by the cloud provider) connecting each region to at least one other region. This infrastructure design enables users of a cloud provider network, such as service provider network 102, to design their applications to run in multiple physical availability zones and/or multiple regions to achieve greater fault-tolerance and availability. For example, because the various regions and physical availability zones of a cloud provider network, such a service provider network 102, are connected to each other with fast, low-latency networking, users can architect applications that automatically failover between regions and physical availability zones with minimal or no interruption to users of the applications should an outage or impairment occur in any particular region.

The traffic and operations of the service provider network 102 may broadly be subdivided into two categories in various embodiments: control plane operations carried over a logical control plane and data plane operations carried over a logical data plane. While the data plane represents the movement of user data through the distributed computing system, the control plane represents the movement of control signals through the distributed computing system. The control plane generally includes one or more control plane components distributed across and implemented by one or more control servers. Control plane traffic generally includes administrative operations, such as system configuration and management (e.g., resource placement, hardware capacity management, diagnostic monitoring, system state information). The data plane includes customer resources that are implemented on the cloud provider network (e.g., computing instances, containers, block storage volumes, databases, file storage). Data plane traffic generally includes non-administrative operations such as transferring customer data to and from the customer resources. Certain control plane components (e.g., tier one control plane components such as the control plane for a virtualized computing service) are typically implemented on a separate set of servers from the data plane servers, while other control plane components (e.g., tier two control plane components such as analytics services) may share the virtualized servers with the data plane, and control plane traffic and data plane traffic may be sent over separate/distinct networks.

As mentioned above, service provider network 102 may include a computing service 104, which may be a virtual computing service. A virtual compute service may offer various compute instances to users/clients. A virtual compute instance may, for example, be implemented on one or more resource hosts that comprise one or more servers with a specified computational capacity (which may be specified by indicating the type and number of CPUs, the main memory size, and so on) and a specified software stack (e.g., a particular version of an operating system, which may in turn run on top of a hypervisor). A number of different types of computing devices may be used singly or in combination to implement the compute instances of a virtual compute service in different embodiments, including special purpose computer servers, storage devices, network devices and the like. In some embodiments instance clients or any other users may be configured (and/or authorized) to direct network traffic to a compute instance. In various embodiments, compute instances may attach or map to one or more data volumes provided by a block-based storage service in order to obtain persistent block-based storage for performing various operations.

Compute instances may operate or implement a variety of different platforms, such as general-purpose operating systems, application server instances, Java™ virtual machines (JVMs), special-purpose operating systems, platforms that support various interpreted or compiled programming languages such as Ruby, Perl, Python, C, C++ and the like, or high-performance computing platforms) suitable for performing client applications, without for example requiring the client to access an instance.

Compute instance configurations may also include compute instances with a general or specific purpose, such as computational workloads for compute intensive applications (e.g., high-traffic web applications, ad serving, batch processing, video encoding, distributed analytics, high-energy physics, genome analysis, and computational fluid dynamics), graphics intensive workloads (e.g., game streaming, 3D application streaming, server-side graphics workloads, rendering, financial modeling, and engineering design), memory intensive workloads (e.g., high performance databases, distributed memory caches, in-memory analytics, genome assembly and analysis), and storage optimized workloads (e.g., data warehousing and cluster file systems). Size of compute instances, such as a particular number of virtual CPU cores, memory, cache, storage, as well as any other performance characteristic. Configurations of compute instances may also include their location, in a particular data center, availability zone, geographic, location, etc., and (in the case of reserved compute instances) reservation term length.

In various embodiments, service provider network 102 may also implement a block-based storage service for providing storage resources and performing storage operations. A block-based storage service is a storage system, composed of a pool of multiple independent resource hosts (e.g., server block data storage systems), which provide block level storage for storing one or more sets of data volumes. Data volumes may be mapped to particular clients, providing virtual block-based storage (e.g., hard disk storage or other persistent storage) as a contiguous set of logical blocks. In some embodiments, a data volume may be divided up into multiple data chunks (including one or more data blocks) for performing other block storage operations, such as snapshot operations or replication operations.

In some embodiments, data storage service 106 may be formatted as an object-based storage service, or a storage service formatted using other storage architectures, that is implemented using a plurality of resource hosts. For example, data storage service 106 may store large quantities of customer data in an efficient manner wherein customer data is stored as data objects with associated keys.

In addition to data storage services (such as data storage service 106), a service provider network 102 may implement other network-based services 110, which may include various different types of analytical, computational, storage, or other network-based system allowing users/clients, as well as other services of service provider network 102 to perform or request various tasks.

Customers/clients of service provider network 102 may convey network-based services requests to the service provider network 102 via an external network 150. In various embodiments, an external network may encompass any suitable combination of networking hardware and protocols necessary to establish network-based communications between clients and the service provider network 102. For example, a network may generally encompass the various telecommunications networks and service providers that collectively implement the Internet. A network may also include private networks such as local area networks (LANs) or wide area networks (WANs) as well as public or private wireless networks. For example, both a given client and service provider network 102 may be respectively provisioned within enterprises having their own internal networks. In such an embodiment, a network may include the hardware (e.g., modems, routers, switches, load balancers, proxy servers, etc.) and software (e.g., protocol stacks, accounting software, firewall/security software, etc.) necessary to establish a networking link between given client and the Internet as well as between the Internet and the service provider network 102. It is noted that in some embodiments, clients may communicate with the service provider network 102 using a private network rather than the public Internet.

In some embodiments, software testing service 108 may further include test plan storage 112, which is configured to store customer-provided test plans for testing software. Test plan storage 112 may also store standard tests, such as are required to achieve various levels of certification. Software testing service 108 also includes test execution orchestration 114, which executes a given test plan stored in test plan storage 112. For example, test execution orchestration 114 may execute a test run comprising multiple tests that are defined in test plan storage 112. Also, test execution orchestration 114 may coordinate with computing service 104 and storage service 106 to emulate a vehicle environment in which the test run is to be carried out, as well as to store results of the tests and/or logs generated while performing the tests. In some embodiments, test execution orchestration 114 may also coordinate testing on real-world vehicles. For example, by providing a test script to one or more vehicles of a test fleet and by receiving test results back from the test vehicles. Results of the testing and/or other information generated as part of performing the testing may be stored in test results storage 116, which in some embodiments may use storage service 106 to provide storage capacity.

Software testing service 108 also includes test failure handling 118, which automatically instantiates a plurality of computing instances of computing service 104, in response to detection of a test failure and further automatically uses the instantiated instances, in parallel, to reproduce the failure and determine a reproducibility measure for the failure. If the failure is reproducible, test failure handling service 118 further implements expanded logging and uses logs generated during re-testing of reproducible failures and a trained machine learning model to automatically determine possible root causes of the failure.

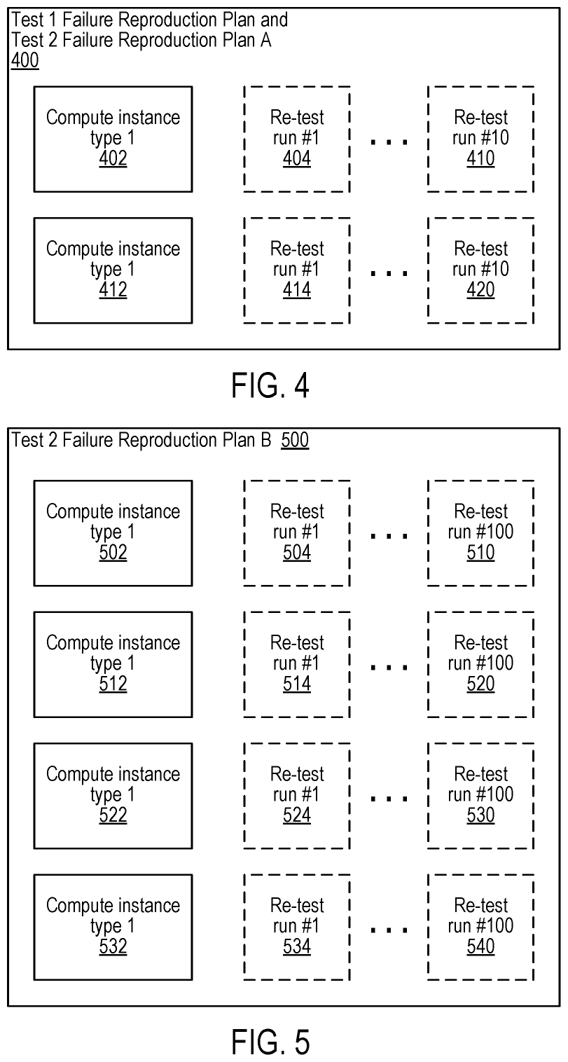

In some embodiments, test failure handing module 118 includes a failure detection module 120, configured to detect, or otherwise receive, an indication of a failure occurring during software testing being performed by software testing service 108. Failure reproducibility evaluation 122 coordinates repeated execution of the failed test, in parallel, on the automatically instantiated computing instances to determine a reproducibility measure for the failure. As further described in FIGS. 4-7, various failure reproduction plans may be used, and selection of more aggressive failure reproduction plans may be made (e.g., scaled up) based on an inability to reproduce the failure using a less aggressive failure reproduction plan.

For failures that can be reproduced, e.g., that have a reproducibility measure greater than a threshold, re-testing is performed that focuses on the conditions that were determined to reproduce the failure and which uses expanded logging to better understand the causes of the failure. Re-test execution orchestration 124 coordinates the re-testing and retest log management 126 may coordinate the expanded logging. In some embodiments, a machine learning model, such as described in FIG. 11, may be used to strategically implement expanded logging for some, but not all, tasks performed during the re-testing.

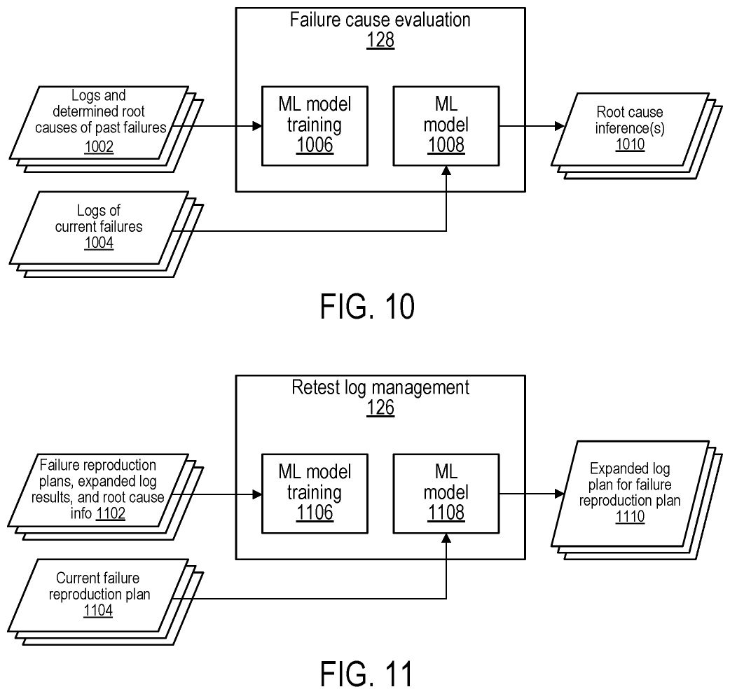

Failure cause evaluation 128 may use another trained machine learning model, such as described in FIG. 10, to determine one or more inferences regarding a root cause of the failure. For example, the machine learning model may have been trained using annotated training data for prior failures, wherein a software engineer determined the root cause for the prior failure and created an annotated record, that includes the logs associated with the prior failure as well as the determined root cause of the prior failure.

Communication interface 130 may then provide the determined one or more inferred root causes to a user, such as by attaching the determined inferred root causes to a ticket provided to a developer using the software testing service 108.

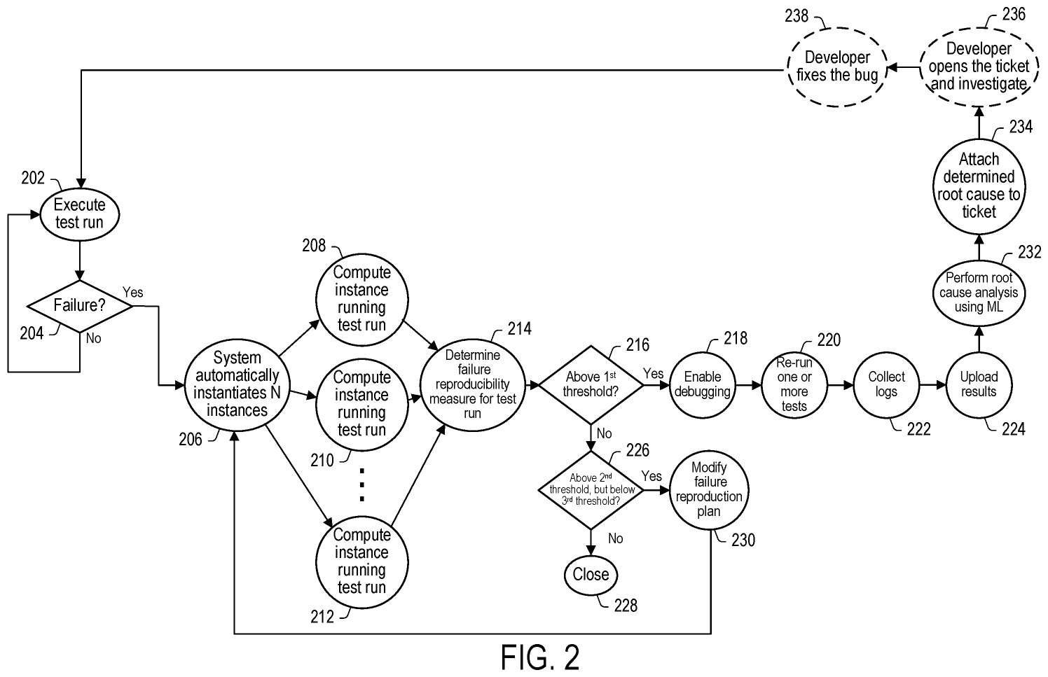

FIG. 2 illustrates a logical diagram of actions performed by a test failure handling module of a software testing service in response to a failure occurring during a test of a test run being executed by the software testing service, according to some embodiments.

In some embodiments, test execution orchestration 114 may be coordinating execution of a test run at 202, when for a given test of the test run, a failure is detected at 204. Note that the test execution orchestration 114 may continue to perform other tests of the test run, while the test with which a failure is associated is handled by a test failure handling module 118, which may perform various ones of the actions shown in FIG. 2. For example, failure detection 120 may receive or detect, at 204, an indication of the failure and failure reproducibility evaluation 112 may, at 206, automatically instantiate a plurality of computing instances of computing service 104. At 208-212, the plurality of computing instances re-run the test with which the failure is associated. At 214, failure reproducibility evaluation 122 determines a failure reproducibility measure for the failure. If above a first threshold, at 216, (e.g., indicating the failure is readily reproducible) re-test execution orchestration 124 enables debugging at 218 and re-runs the test at 220, for example with expanded logging (e.g., debugging) implemented.

If the failure reproducibility measure does not satisfy the first threshold at 216, further decisions about reproducibility are made at 226. For example, if the reproducibility measure is below a second threshold (e.g., indicating the failure cannot be reproduced), then the failure ticket is closed at 228 and the communication interface 130 may provide a message to the developer of the software indicating that a failure has occurred, but that the failure cannot be reproduced. However, if the reproducibility measure is above the second threshold, but below the first threshold, the reproducibility measure may be compared to a third threshold (e.g., indicating that a better reproducibility measure can be obtained by repeating the re-testing using a different failure reproduction plan, such as those described in FIGS. 5-7). For example, at 230, a different failure reproduction plan may be selected and the process may revert to 206, wherein another set of computing instances is automatically instantiated as specified in the different failure reproduction plan.

When re-testing is performed for failures that are reproducible (e.g., at 220) logs may be collected at 222, and the logs may include both standard logs and expanded logs, wherein expanded logging is implemented during the re-testing. The log results and re-test results are uploaded, at 224, to test results storage 116. Also, at 232, failure cause evaluation 128 performs root cause analysis using a trained machine learning model, such as described in FIG. 10.

At 234, the determined inferred root cause is attached to a ticket, for example by communication interface 130, and, at 234, is provided to a developer for further investigation and/or resolution of the failure. At 238, the developer may fix the bug causing the failure and may repeat the test using the repaired software.

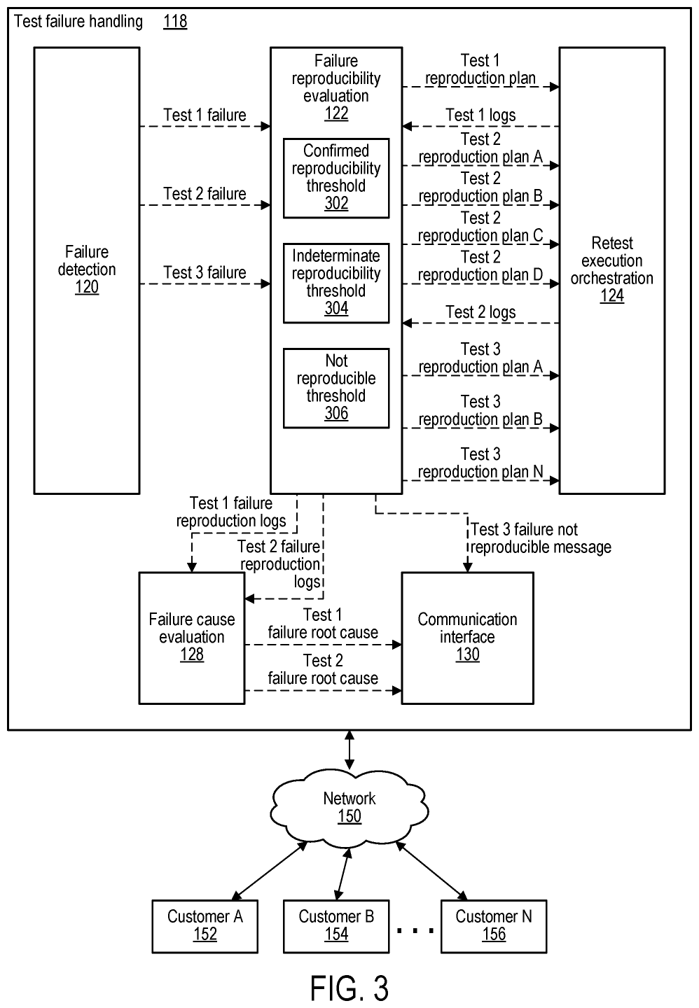

FIG. 3 illustrates example interactions between components of the test failure handling module in response to different fest failures having different reproducibility measures, according to some embodiments.

As an example, failure detection module 120 may detect three different test failures under different circumstances, a first test failure that is easily reproducible (e.g., test 1 failure), a second test failure that is more difficult to reproduce, but that is reproducible (e.g., test 2 failure), and a third test failure that is not reproducible (e.g., test 3 failure). Note that these are just given as examples of test failures with different levels of reproducibility and may not occur sequentially and may or may not occur during a single test run.

For the test 1 failure, failure reproducibility evaluation 122 selects a default failure reproduction plan, such as shown in FIG. 4 and retest execution orchestration 124 coordinates re-producing the test 1 failure using a plurality of computing instances that enable parallelized execution for determining a reproducibility measure for the test 1 failure. In this example, the reproducibility measure for the test 1 failure meets or exceeds confirmed reproducibility threshold 302. Therefore, re-testing is performed with expanded logging (also orchestrated by retest execution service 124) and test 1 re-test logs are provided back (and forwarded to) failure cause evaluation 128, which determines a root cause of failure 1 and communicates the root cause to one or more of customers 152 through 156 via network 150.

For the test 2 failure, failure reproducibility evaluation 122 selects a default failure reproduction plan, such as shown in FIG. 4 and retest execution orchestration 124 coordinates re-producing the test 2 failure using a plurality of computing instances that enable parallelized execution for determining a reproducibility measure for the test 2 failure using the default failure reproduction plan. However, in this example, failure 2 is not reproducible to an extent that confirmed reproducibility threshold 302 is satisfied. However, failure 2 is sufficiently reproducible such that the not reproducible threshold 306 is not triggered. Additionally, intermediate reproducibility threshold 304 is triggered, such that failure reproducibility evaluation 122 attempts to reproduce failure 2 using alternative failure reproduction plans B through D, such as shown in FIGS. 5-7. Subsequently, the confirmed reproducibility threshold 302 is satisfied when using one of the alternative failure reproduction plans and re-testing is performed using expanded logs. In a similar manner as for the test 1 failure, a root cause of the test 2 failure is determined and provided to one or more of the customers.

For the test 3 failure, multiple failure reproduction plans are also executed. However, it is determined that failure 3 satisfies the not reproducible threshold 306. Thus, a test 3 not reproducible message is returned to the one or more customers via communication interface 130.

FIG. 4 illustrates an example failure reproduction plan to be executed by a retest execution orchestration module of the test failure handling module, according to some embodiments.

As an example, an initial failure reproduction plan 400 may involve multiple compute instances, such as compute instances 402 and 412, which perform multiple executions of a test for which a failure is attempting to be reproduced. For example, compute instance 402 executes re-test runs 404 through 410 and compute instance 412 executes re-test runs 414 through 420.

FIG. 5 illustrates another example failure reproduction plan, for example that may be used to determine a reproducibility measure for failures that are less reproducible than failures for which the failure reproduction plan shown in FIG. 4 is used, according to some embodiments.

As another example, the number of compute instances used to perform re-test executions may be increased and the number of re-test executions each compute instance performs may be increased, or both may be increased. For example, an alternative failure reproduction plan 500 involves compute instances 502, 512, 522, and 532 performing re-test executions 504 through 510, 514 through 520, 524 through 530, and 534 through 540, respectively.

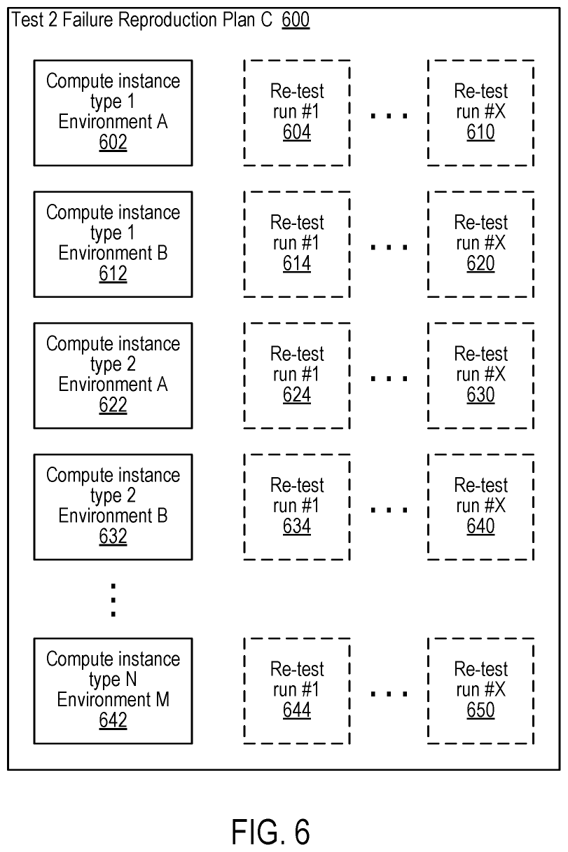

FIG. 6 illustrates an additional example failure reproduction plan, wherein compute instance type and/or compute instance environment are varied to better reproduce the failure, according to some embodiments.

In some embodiments, an alternative failure reproduction plan, such as failure reproduction plan 600, may include varied types of computing instances and/or varied environmental conditions. For example, failure reproduction plan 600 includes compute instance type 1 operating in environment A (602), compute instance type 1 operating in environment B (612), compute instance type 2 operating in environment A (622), compute instance type 2 operating in environment type B (632) and may include more types of computing instances operating in more types of environmental conditions, such as compute instance type N operating in environment M. In the example shown in FIG. 6, compute instance 602 performs re-test executions 604 through 610, compute instance 612 performs re-test executions 614 through 620, compute instance 622 performs re-test executions 624 through 630, compute instance 632 performs re-test executions 634 through 640, and compute instance 642 performs re-test executions 644 through 650. Note that in various embodiments the different compute instances may perform the same or different numbers of re-test executions.

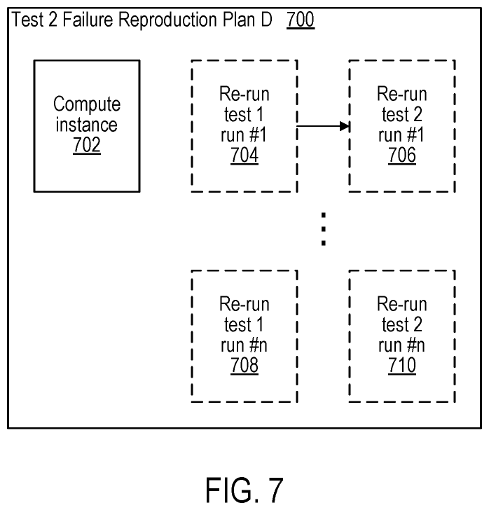

FIG. 7 illustrates yet another example failure reproduction plan, wherein runtime context is expanded by performing a threshold number of prior tests (that passed) prior to repeating the test that failed, according to some embodiments.

In some situations, failures may be reproducible when runtime conditions such as processor load and/or memory usage are recreated, but may otherwise not be reproducible. In order to recreate such runtime conditions, other tests that were executed prior to the test that failed may also be repeated when determining a failure reproducibility measure. For example, failure reproduction plan 700 includes compute instance 702 executing a re-run of both test 1 (704) and test 2 (706) and repeating this sequential re-run of the two test multiple times. For example, test 1 re-run is repeated (708) and test 2 re-run is repeated (710).

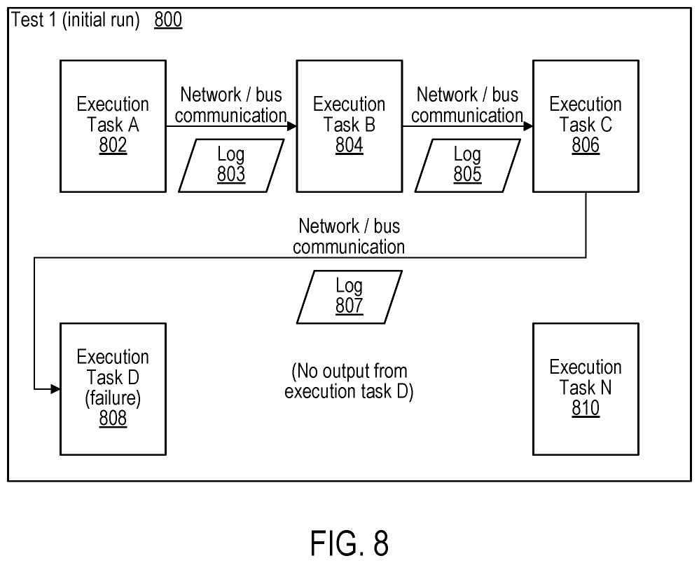

FIG. 8 illustrates logging performed during a test of a test run (for example under normal testing conditions prior to detecting a failure), according to some embodiments.

In some embodiments, under normal testing conditions (e.g., without a detected failure) at least some logging may be performed, but it may be limited. For example, logging may be performed for bus or network traffic, but not for internal tasks of a test. For example, logs 803, 805, and 807 are generated during initial run 800 of test 1, for communications between task A (802), task B (804), task C (806), and task D (808). In this example, a failure may occur with respect to task D (808), such that there is no communication to task N (810) and therefore no communication log between task D (808) and task N (810).

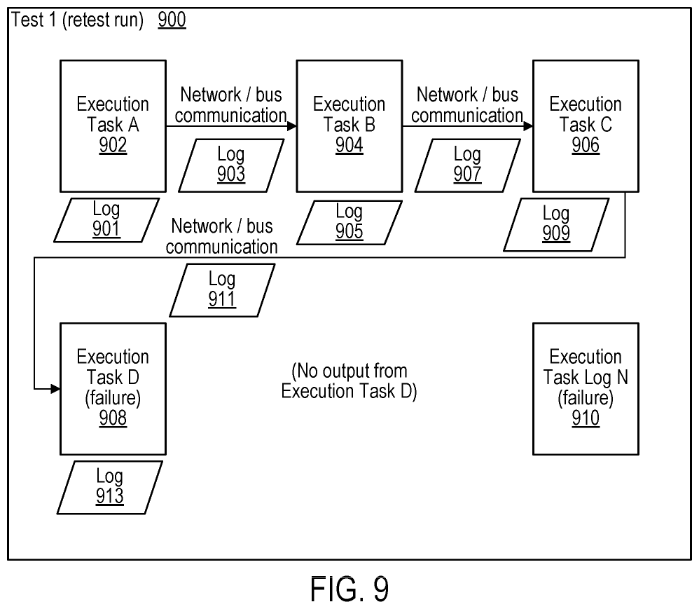

FIG. 9 illustrates logging performed during a re-test of a rest run (for which a failure has been detected), wherein expanded logging is performed, according to some embodiments.

However, as compared to the initial run 800, during a re-test run 900, logging may be expanded. For example, log 901 is generated for task A (902), communication log 903 is generated for communications between task A (902) and task B (904). Also, log 905 is generated for task B (904). Communication log 907 is generated for communications between task B (904) and task C (906). Also, log 909 is generated for task C (906). Communication log 911 is generated for communications between task C (906) and task D (908). Also, log 913 is generated for task D (908). In this example, the failure occurs at task D (908), thus there is no log generated for communication on to task N (910).

While expanded logging is shown for each task and network communication shown in retest run 900, in some embodiments expanded logging may be selectively applied only to tasks that are likely to be the cause of the failure. In some embodiments, a trained ML model, as shown in FIG. 11, may be used to select which tasks for which expanded logging is to be performed.

FIG. 10 illustrates a process for training and using a machine learning model to determine root causes of failures based on expanded logs generated during re-testing, according to some embodiments.

In some embodiments, failure cause evaluation module 128 may include ML model training 1006 and a trained ML model 1008. The ML model trainer 1006 may train the ML model 1008 using logs and determined root causes 1002 from past failures. For example, a software engineer, or other technician, may have already evaluated the past failures to determine root causes, and these determined root causes and associated logs may be used to train the ML model. Also, during software testing, logs of current failures 1004 may be provided to the trained ML model 1008, which generates root cause inferences 1010. These root cause inferences may be attached to a failure report ticket, or may otherwise be provided to a developer for use in correcting the failure.

FIG. 11 illustrates a process for training and using a machine learning model to generate expanded logging plans, wherein expanded logging is strategically deployed to software tasks that are predicted to be associated with a failure that is trying to be reproduced, according to some embodiments.

In some embodiments, retest log management 126 may include ML model training 1106 and a second trained ML model 1108 (in addition to the first ML model 1008 included in failure cause evaluation 128). The ML model trainer 1106 may train the ML model 1108 using past failure reproduction plans, expanded log results, and determined root cause information 1102. Also, current failure reproduction plans 1104 may be provided to the trained ML model 1108 to generate inferences about which tasks for which expanded logging should be enabled, such as an expanded log plan for a given failure reproduction plan (1110).

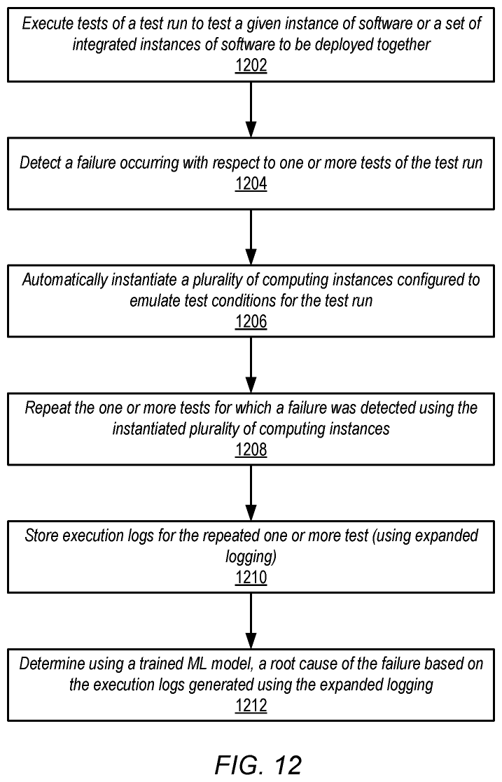

FIG. 12 is a flowchart illustrating a process of determining a root cause for a failure occurring during a given test of a test run, wherein automatic instantiation of computing instances is used to reproduce the failure and a machine learning model is used to analyze re-test logs to determine a root cause of the failure, according to some embodiments.

At block 1202, a software testing service, such as software testing service 108, executes tests of a test run to test a given instance of software or a set of integrated instances of software to be deployed together. At block 1204, a failure is detected with respect to one or more of the tests of the test run. At block 1206, the software testing service automatically instantiates a plurality of computing instances configured to emulate test conditions for the test run with which the detected failure is associated. At block 1208, the software testing service repeats the one or more tests for which a failure was detected using the instantiated plurality of computing instances. Then, at block 1210, the software testing service stores execution results and logs for the tests. Also, at block 1212, the software testing service uses a trained ML model to determine a root cause of the failure. As explained in FIGS. 2-7, in some embodiments, a reproducibility measure may first be determined and failure reproduction plans (used to perform the re-testing) may be adjusted in order to reproduce the failure. Also, as explained in FIGS. 8 and 9, expanded logging may be employed when performing the re-testing, and the expanded logging may be selectively applied to target tasks with which the failure is likely associated. Also, as explained in FIGS. 10-11, trained ML models may be used to determine the selective logging as well as to determine the root cause.

### Example Computer System

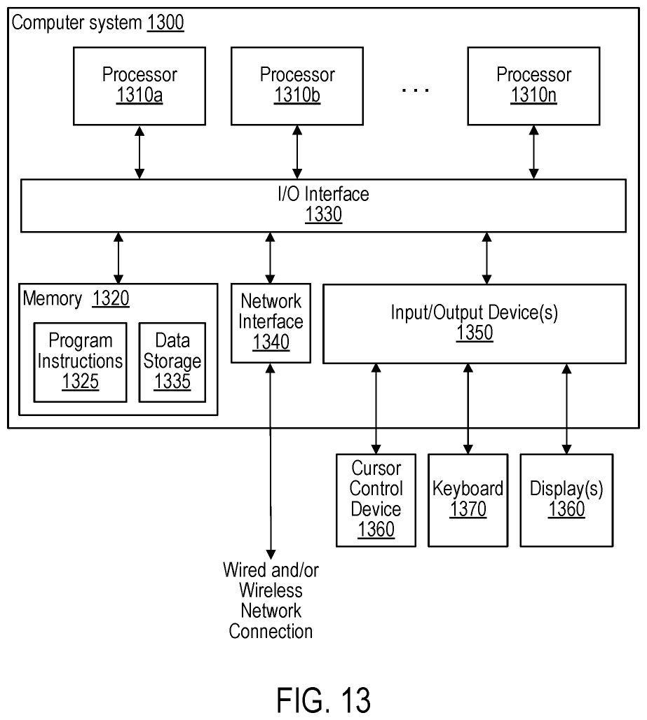

Any of various computer systems may be configured to implement processes associated with a cloud-based software testing service, a test failure handling service, an operating system in a vehicle or device, or any other component of the above figures. For example, FIG. 13 illustrates a block diagram illustrating an example computer system that implements some or all of the techniques described herein, according to some embodiments. In various embodiments, the cloud-based service provider network 100, or any other component of the above figures FIGS. 1-12 may each include one or more computer systems 1300 such as that illustrated in FIG. 13.

In the illustrated embodiment, computer system 1300 includes one or more processors 1310 coupled to a system memory 1320 via an input/output (I/O) interface 1330. Computer system 1300 further includes a network interface 1340 coupled to I/O interface 1330. In some embodiments, computer system 1300 may be illustrative of servers implementing enterprise logic or that provide a downloadable application, while in other embodiments servers may include more, fewer, or different elements than computer system 1300.

In various embodiments, computing device 1300 may be a uniprocessor system including one processor or a multiprocessor system including several processors 1310a-1310n (e.g., two, four, eight, or another suitable number). Processors 1310a-1310n may include any suitable processors capable of executing instructions. For example, in various embodiments, processors 1310a-1310n may be processors implementing any of a variety of instruction set formats (ISAs), such as the x86, PowerPC, SPARC, or MIPS ISAs, or any other suitable ISA. In some embodiments, processors 1310a-1310n may include specialized processors such as graphics processing units (GPUs), application specific integrated circuits (ASICs), etc. In multiprocessor systems, each of processors 1310a-1310n may commonly, but not necessarily, implement the same ISA.

System memory 1320 may be configured to store program instructions and data accessible by processor(s) 1310a-1310n. In various embodiments, system memory 1320 may be implemented using any suitable memory technology, such as static random-access memory (SRAM), synchronous dynamic RAM (SDRAM), nonvolatile/Flash-type memory, or any other type of memory. In the illustrated embodiment, program instructions and data implementing one or more desired functions, such as those methods, techniques, and data described above, are shown stored within system memory 1320 as code (e.g., program instructions) 1325 and data storage 1335.

In one embodiment, I/O interface 1330 may be configured to coordinate I/O traffic between processors 1310a-1310n, system memory 1320, and any peripheral devices in the device, including network interface 1340 or other peripheral interfaces. In some embodiments, I/O interface 1330 may perform any necessary protocol, timing, or other data transformations to convert data signals from one component (e.g., system memory 1320) into a format suitable for use by another component (e.g., processor 1310). In some embodiments, I/O interface 1330 may include support for devices attached through various types of peripheral buses, such as a variant of the Peripheral Component Interconnect (PCI) bus standard or the Universal Serial Bus (USB) standard, for example. In some embodiments, I/O interface 1330 may include support for devices attached via an automotive CAN bus, etc. In some embodiments, the function of I/O interface 1330 may be split into two or more separate components, such as a north bridge and a south bridge, for example. Also, in some embodiments, some, or all of the functionality of I/O interface 1330, such as an interface to system memory 1320, may be incorporated directly into processors 1310a-1310n.

In some embodiments, the network interface 1340 may be coupled to I/O interface 1330, and one or more input/output devices 1350, such as cursor control device 1360, keyboard 1370, and display(s) 1380. In some cases, it is contemplated that embodiments may be implemented using a single instance of computer system 1300, while in other embodiments multiple such computer systems, or multiple nodes making up computer system 1300, may be configured to host different portions or instances program instructions as described above for various embodiments. For example, in one embodiment some elements of the program instructions may be implemented via one or more nodes of computer system 1300 that are distinct from those nodes implementing other elements.

Network interface 1340 may be configured to allow data to be exchanged between computing device 1300 and other devices associated with a network or networks. In various embodiments, network interface 1340 may support communication via any suitable wired or wireless general data networks, such as types of ethernet networks, cellular networks, Bluetooth networks, Wi-Fi networks, Ultra-wideband Networks, for example. Additionally, network interface 1340 may support communication via telecommunications/telephony networks such as analog voice networks or digital fiber communications networks, via storage area networks such as Fibre Channel SANs, or via any other suitable type of network and/or protocol.

In some embodiments, system memory 1320 may be one embodiment of a computer-readable (e.g., computer-accessible) medium configured to store program instructions and data as described above for implementing embodiments of the corresponding methods, systems, and apparatus. However, in other embodiments, program instructions and/or data may be received, sent, or stored upon different types of computer-readable media. Generally speaking, a computer-readable medium may include non-transitory storage media or memory media such as magnetic or optical media, e.g., disk or DVD/CD coupled to computing device 1300 via I/O interface 1330. One or more non-transitory computer-readable storage media may also include any volatile or non-volatile media such as RAM (e.g., SDRAM, DDR SDRAM, RDRAM, SRAM, etc.), ROM, etc., that may be included in some embodiments, of computing device 1300 as system memory 1320 or another type of memory. Further, a computer-readable medium may include transmission media or signals such as electrical, electromagnetic, or digital signals, conveyed via a communication medium such as a network and/or a wireless link, such as may be implemented via network interface 1340. Portions or all of multiple computing devices such as that illustrated in FIG. 13 may be used to implement the described functionality in various embodiments; for example, software components running on a variety of different devices and servers may collaborate to provide the functionality. In some embodiments, portions of the described functionality may be implemented using storage devices, network devices, or various types of computer systems. The term “computing device” and “ECU” as used herein, refers to at least all these types of devices, and is not limited to these types of devices.

The various methods as illustrated in the figures and described herein represent illustrative embodiments of methods. The methods may be implemented manually, in software, in hardware, or in a combination thereof. The order of any method may be changed, and various elements may be added, reordered, combined, omitted, modified, etc. For example, in one embodiment, the methods may be implemented by a computer system that includes a processor executing program instructions stored on a computer-readable storage medium coupled to the processor. The program instructions may be configured to implement the functionality described herein (e.g., the functionality of the data transfer tool, various services, databases, devices and/or other communication devices, etc.).

Various modifications and changes may be made as would be obvious to a person skilled in the art having the benefit of this disclosure. It is intended to embrace all such modifications and changes and, accordingly, the above description to be regarded in an illustrative rather than a restrictive sense.

Various embodiments may further include receiving, sending, or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g., SDRAM, DDR, RDRAM, SRAM, etc.), ROM, etc., as well as transmission media or signals such as electrical, electromagnetic, or digital signals, conveyed via a communication medium such as network and/or a wireless link.

What is claimed is:

1. A system comprising:
a first set of one or more computing devices comprising hardware configured to emulate one or more execution environments of a vehicle; and
one or more computing devices configured to implement a vehicle software testing service configured to:
perform one or more test runs of a given instance of vehicle software that is to be tested via the vehicle software testing service, wherein a given one of the test runs comprises a plurality of individual tests;
detect a failure occurring with respect to one or more of the tests of the test run;
automatically, in response to detecting the failure, instantiate a plurality of computing instances using the first set of one or more computing devices, wherein the plurality of computing instances are configured to emulate test conditions for at least of the one or more tests with relation to which the failure occurred;
repeat the one or more tests with relation to which the failure occurred, using the instantiated computing instances, a threshold number of times;
store execution logs for the repeated one or more tests; and
determine, using a trained machine learning model, a root cause of the failure, wherein the stored execution logs are provided to the machine learning model for use in generating an inference result used in determining the root cause of the failure.

2. The system of claim 1, wherein the vehicle software testing service is further configured to:
automatically expand execution log generation to include execution logs for one or more tasks included in the one or more tests with relation to which the failure occurred,
wherein the stored execution logs include bus or network logs for communications between software elements performing the tasks associated with the one or more tests and include the automatically expanded execution logs generated with regard to execution of the one or more tasks.

3. The system of claim 1, wherein the vehicle software testing service is further configured to:
determine a reproducibility measure for the failure based on results of the repeated one or more tests.

4. The system of claim 3, wherein said determining the root cause is performed in response to determining the reproducibility measure for the failure satisfies a first reproducibility threshold.

5. The system of claim 3, wherein the vehicle software testing service is further configured to:
return a message indicating the failure is not reproducible, without determining the root cause, in response to determining the reproducibility measure for the failure satisfies a second reproducibility threshold.

6. The system of claim 3, wherein the vehicle software testing service is further configured to:
modify a re-test execution plan used to perform the repeated one or more tests, in response to determining the reproducibility measure for the failure satisfies a third reproducibility threshold.

7. The system of claim 6, wherein modifying the re-test execution plan comprises:
instantiating a larger number of the computing instances configured to emulate the test conditions for the at least of the one or more tests; and
repeating the one or more tests using the larger number of computing instances.

8. The system of claim 6, wherein modifying the re-test execution plan comprises:
increasing a number of times the one or more tests are repeatedly executed using a given one of the plurality of computing instances.

9. The system of claim 1 wherein modifying the re-test execution plan comprises:
modifying one or more computing contexts in which the repeated execution of the one or more tests are performed.

10. The system of claim 9, wherein the modified one or more contexts comprises:
a modified hardware platform, a modified software platform, or a modified environmental condition for the first set of computing devices used to perform the repeated testing.

11. The system of claim 9, wherein the modified one or more contexts comprises:
a modified runtime condition in which the repeated testing is performed, wherein to modify the runtime condition one or more additional preceding tests of the test run are performed as part of repeating the one or more tests, wherein the one or more preceding tests preceded the one or more tests with relation to which the failure occurred.

12. A method comprising:
performing one or more test runs of a given instance of software that is to be tested, wherein a given one of the test runs comprises a plurality of individual tests;
detecting a failure occurring with respect to one or more of the tests of the test run;
automatically, in response to detecting the failure, instantiating a plurality of computing instances configured to emulate test conditions for at least one of the one or more tests with relation to which the failure occurred, wherein the plurality of computing instances are instantiated using a set of computing devices that emulate one or more execution environments into which the software is to be deployed;
repeating the one or more tests with relation to which the failure occurred, using the instantiated computing instances, a threshold number of times;
storing execution logs for the repeated one or more tests; and
determining, using a trained machine learning model, a root cause of the failure, wherein the stored execution logs are provided to the machine learning model for use in generating an inference result used in determining the root cause of the failure.

13. The method of claim 12, further comprising:
automatically expanding execution log generation to include execution logs for one or more tasks included in the one or more tests with relation to which the failure occurred,
wherein the stored execution logs include bus or network logs for communications between software elements performing the tasks associated with the one or more tests and the automatically expanded execution logs generated with regard to execution of the one or more tasks.

14. The method of claim 13, further comprising:
training a second machine learning model to determine which tasks for which expanded logging is to be performed, wherein training the second machine learning model comprises:
providing the first machine learning model:
logs generated for past failures; and
root causes determined for the past failures,
wherein said automatically expanding the execution logs is performed using a log expansion plan generated using the trained second machine learning model.

15. The method of claim 12, further comprising:
training a machine learning model to generate the trained machine learning model used to determine the root cause, wherein said training comprises:
providing the machine learning model annotated training data comprising:
execution logs for prior failures; and
determined root causes, determined for the prior failures.

16. The method of claim 12, wherein the given test run comprises an integration test for integration of a plurality of software modules to be deployed to a vehicle.

17. The method of claim 12, wherein the given test run comprises a software module test for a software module to be deployed to a vehicle.

18. One or more non-transitory, computer-readable, storage media storing program instructions that, when executed one or across one or more processors, cause the one or more processors to:
detect a failure occurring with respect to one or more tests of a test run;
automatically, in response to detecting the failure, cause a plurality of computing instances to be instantiated, wherein the plurality of computing instances are configured to emulate test conditions for at least one of the one or more tests with relation to which the failure occurred, wherein the plurality of computing instances are instantiated using a set of computing devices that emulate one or more execution environments into which the software is to be deployed;
cause the one or more tests with relation to which the failure occurred to be repeated, using the instantiated computing instances, a threshold number of times;
store execution logs for the repeated one or more tests; and
determine, using a trained machine learning model, a root cause of the failure, wherein the stored execution logs are provided to the machine learning model for use in generating an inference result used in determining the root cause of the failure.

19. The one or more non-transitory, computer-readable, storage media of claim 18, wherein the program instruction, when executed on or across the one or more processors, cause the one or more processors to:
determine a reproducibility measure for the failure based on results of the repeated one or more tests;
perform the determining of the root cause in response to the reproducibility measure satisfying a first threshold;
return a message indicating the failure is not reproducible, without determining the root cause, in response to the reproducibility measure satisfying a second threshold; and
modify a re-test execution plan used to perform the repeated one or more tests, in response to the reproducibility measure satisfying a third threshold.

20. The one or more non-transitory, computer-readable, storage media of claim 18, wherein the program instruction, when executed on or across the one or more processors, cause the one or more processors to:
automatically expand execution log generation to include execution logs for one or more tasks included in the one or more tests with relation to which the failure occurred.
